(19) United States
(12) Patent Application Publication
(10) Pub. No.: US 2026/0196372 A1
(43) Pub. Date: Jul. 9, 2026

(54) GASEOUS XENON-BASED NUCLEAR VOLTAIC POWER SOURCE USING RADIOISOTOPES IN AEROSOL FORM

(71) Applicants: Nima Golsharifi, London (GB); Mohamed Abdelbaset Ahmed, Florence (IT)

(72) Inventors: Nima Golsharifi, London (GB); Mohamed Abdelbaset Ahmed, Florence (IT)

(21) Appl. No.: 19/556,743

(22) Filed: Mar. 4, 2026

(51) Int. Cl. G21H 1/04; G02B 5/08; G21H 1/12

(52) U.S. Cl. CPC G21H 1/04; G02B 5/0891; G21H 1/12

(57) ABSTRACT

A nuclear voltaic power source utilizing gaseous xenon as a scintillation converting medium combined with radioisotopes dispersed in aerosol form. The radioisotope aerosol particles are uniformly distributed within gaseous xenon maintained at 1-2 atmospheres, creating a volumetric active region where ionizing radiation interacts with xenon atoms to produce excimer scintillation photons at approximately 175 nm. These vacuum ultraviolet photons are absorbed by wide bandgap semiconductor converters (e.g., diamond, AlN, SiC, GaN) lining the containment structure, generating electron-hole pairs extracted as electrical current. The aerosol particle size is optimized for each radioisotope to maximize radiation escape into the gas phase. The spherical containment geometry provides maximum photon capture from all emission angles, while low-pressure operation eliminates the need for high-pressure vessels. Multiple cells may be connected in series-parallel arrays for scalable power output.

### CROSS-REFERENCE TO RELATED APPLICATIONS

This application claims the benefit of priority to Singapore Patent Application No. 10202500576V, filed Mar. 6, 2025, entitled “Gaseous Xenon-Based Nuclear Voltaic Power Source Using Radioisotopes in Aerosol Form,” the entire disclosure of which is hereby incorporated by reference.

### FIELD OF THE INVENTION

The present invention relates to nuclear power generation, and more specifically to a nuclear voltaic power source that utilizes gaseous xenon as a scintillation medium in combination with radioisotopes dispersed in aerosol form to convert nuclear radiation energy into electrical power via photon generation and subsequent wide bandgap semiconductor photovoltaic conversion.

### BACKGROUND OF THE INVENTION

Nuclear voltaic systems convert kinetic energy from radioactive decay into electrical energy. Conventional approaches typically employ solid-state semiconductor converters placed adjacent to solid or plated radioisotope sources. These configurations suffer from radiation damage to the semiconductor lattice, limited geometric interaction between the radiation source and converter, and self-absorption losses in the radioisotope layer.

Gaseous scintillation media, particularly noble gases, offer an alternative pathway for radiation-to-electrical energy conversion. When ionizing radiation interacts with xenon gas, it produces excited-state dimers (excimers) that emit vacuum ultraviolet (VUV) photons at approximately 175 nm as they relax to the ground state. This excimer-based scintillation mechanism is well-characterized in particle physics detectors and medical imaging.

The concept of dispersing radioactive material as fine aerosol particles within a scintillating gas medium provides a volumetric interaction geometry that maximizes the radiation-gas interaction cross-section. Unlike planar solid-state configurations where radiation must traverse from a surface, the aerosol-in-gas configuration enables radiation emission in all directions from each suspended particle, with the surrounding gas medium capturing energy from every emission angle. This approach eliminates self-absorption losses inherent in solid radioisotope layers.

However, prior optoelectric nuclear battery concepts using gaseous scintillators have not specified optimal aerosol particle sizes for specific radioisotopes, have not addressed the particular advantages of xenon at low pressures (1-2 atmospheres), and have not described the integration of wide bandgap semiconductor converters optimized for VUV photon absorption from excimer emission. The present invention addresses these gaps.

### SUMMARY OF THE INVENTION

The present invention provides a nuclear voltaic power source comprising: (a) at least one radioisotope dispersed in aerosol form within a gaseous medium; (b) gaseous xenon as a scintillation converting medium maintained at a pressure of approximately 1 to 2 atmospheres and an operating temperature from sub-zero temperatures up to approximately 60 degrees Celsius; (c) at least one wide bandgap semiconductor converter for absorbing scintillation photons generated by xenon excimers and converting them into electron-hole pairs; (d) electrical contacts for charge extraction; and (e) a containment and radiation shielding structure.

The radioisotope aerosol particles are uniformly dispersed within the gaseous xenon, creating a volumetric active region where ionizing radiation from each aerosol particle interacts with surrounding xenon atoms to produce scintillation photons. The aerosol particle size is optimized for each radioisotope to maximize radiation emission into the gas phase while maintaining aerosol stability. The spherical containment geometry ensures maximum photon capture by the wide bandgap semiconductor layer lining the containment interior.

### BRIEF DESCRIPTION OF THE DRAWINGS

FIG. 1 is a cross-sectional view of the spherical nuclear voltaic power source showing the containment structure, gaseous xenon medium with dispersed radioisotope aerosol, wide bandgap semiconductor layer, and electrical contacts.

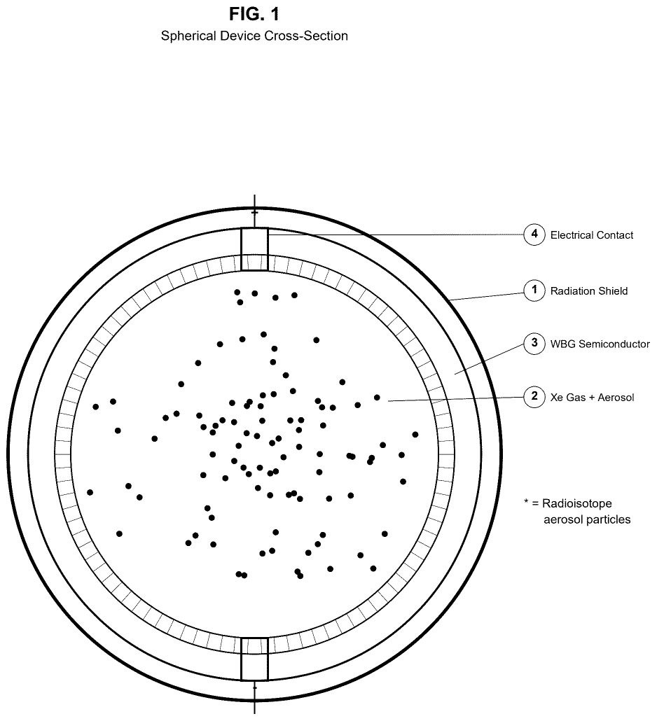

FIG. 2 is a detailed view of the energy conversion mechanism showing radioisotope aerosol particles, xenon scintillation, and photon absorption by the wide bandgap semiconductor.

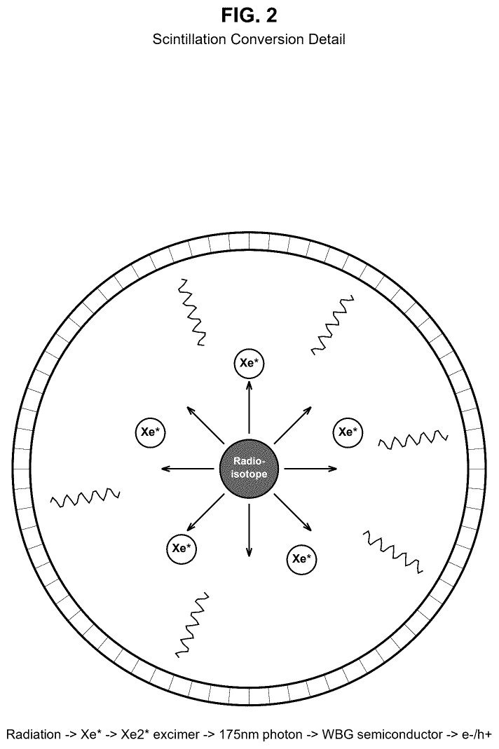

FIG. 3 is a schematic diagram showing the three-stage energy conversion pathway: radiation emission, excimer scintillation, and photovoltaic conversion.

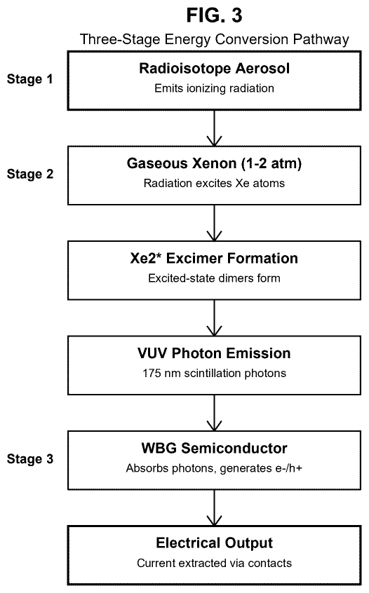

FIG. 4 is a cross-sectional view of an alternative planar configuration of the device.

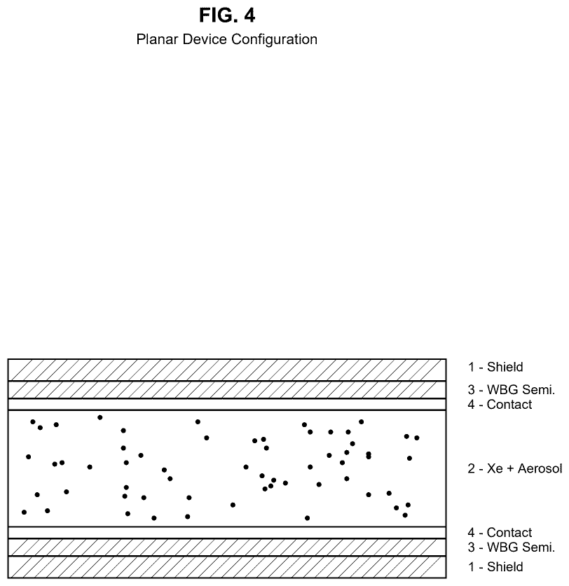

FIG. 5 is a cross-sectional view of a cylindrical configuration of the device.

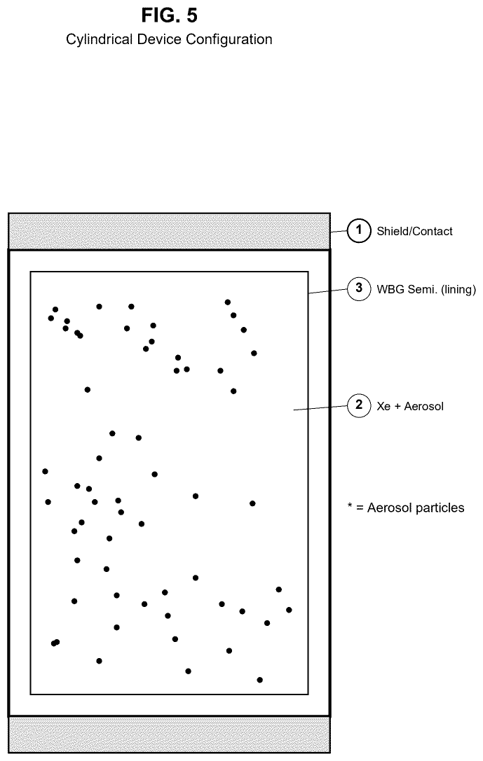

FIG. 6 is a parts reference table listing all reference numerals and corresponding component descriptions.

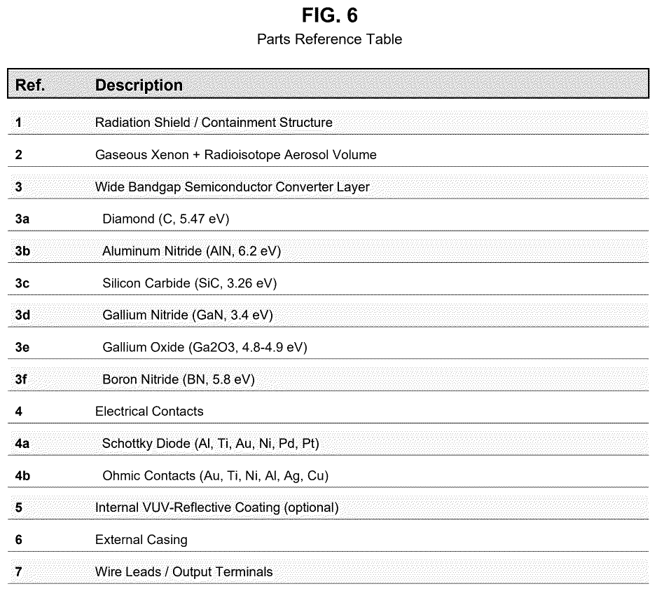

FIG. 7 is a table showing optimal aerosol particle sizes for various radioisotopes in xenon gas.

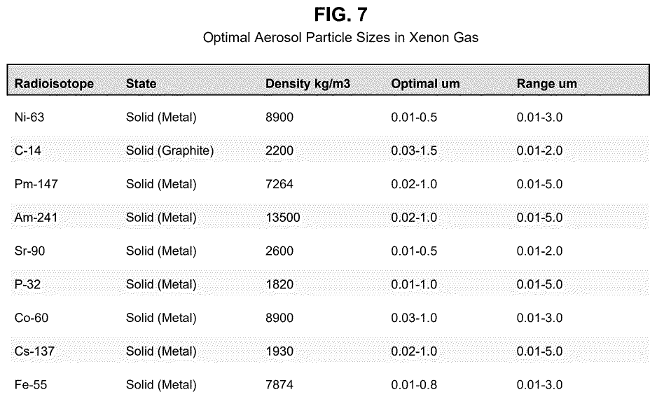

FIG. 8 is a table showing scintillation properties of xenon gas.

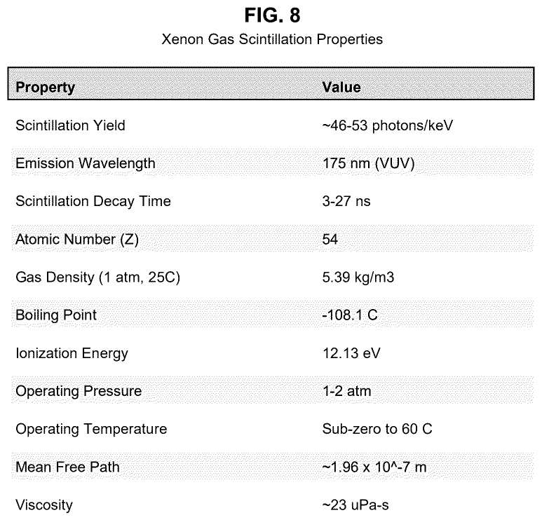

FIG. 9 is a schematic diagram showing a stacked array of multiple power cells connected in series-parallel.

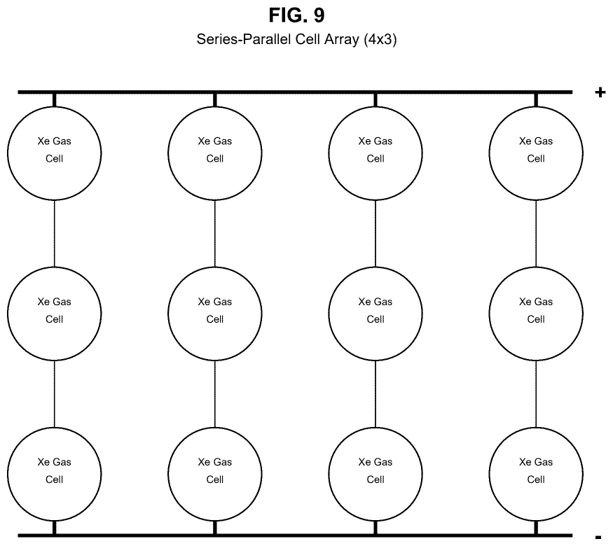

FIG. 10 is a diagram showing the excimer energy level transitions and photon emission spectrum.

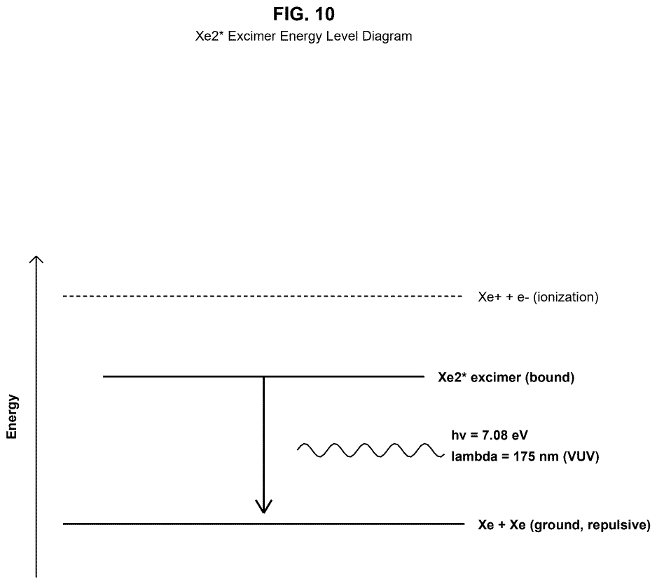

### DETAILED DESCRIPTION OF THE INVENTION

### Energy Conversion Mechanism

The energy conversion pathway proceeds in three stages. First, ionizing radiation (alpha, beta, or gamma) emitted by the radioisotope aerosol interacts with gaseous xenon atoms, producing excited and ionized species. Second, the excited xenon atoms form excimer dimers that relax to the ground state by emitting vacuum ultraviolet photons at approximately 175 nm with a scintillation yield of approximately 46 photons per keV of deposited energy and decay times of approximately 3 to 27 nanoseconds. Third, the VUV photons are absorbed by a wide bandgap semiconductor photovoltaic converter lining the containment structure, generating electron-hole pairs that are extracted as electrical current.

### Gaseous Xenon Scintillation Medium

Xenon gas is selected as the primary scintillation converting medium due to its outstanding properties: high scintillation yield (approximately 46-53 photons per keV), emission wavelength of approximately 175 nm in the vacuum ultraviolet, fast scintillation response (3-27 ns), high atomic number (Z=54) providing efficient radiation stopping power, chemical inertness, and non-toxicity. The xenon is maintained at a pressure of 1 to 2 atmospheres, eliminating the need for high-pressure containment vessels while providing sufficient gas density for effective scintillation.

At the operating pressure range of 1-2 atmospheres, xenon has a gas density of approximately 5.4 kg per cubic meter, a mean free path of approximately 1.96 times 10 to the negative 7 meters, and a viscosity of approximately 23 microPascal-seconds. These properties ensure effective aerosol suspension and efficient energy transfer from ionizing radiation to scintillation photons.

### Radioisotope Aerosol

The radioisotope is dispersed as fine particles in aerosol form within the gaseous xenon. This configuration maximizes the interaction surface area between the radioactive material and the scintillation medium, ensuring that radiation emitted from each particle has maximum probability of interacting with surrounding xenon atoms rather than being absorbed by adjacent radioisotope material.

The aerosol particle size is optimized for each radioisotope based on the radiation type and energy. For beta-emitting isotopes, the optimal particle radius is selected so that the majority of beta particles escape the particle before being self-absorbed. For alpha-emitting isotopes, smaller particle sizes are preferred due to the shorter range of alpha particles. Exemplary optimal particle parameters include: Ni-63 (0.01-0.5 micrometers), C-14 (0.03-1.5 micrometers), Pm-147 (0.02-1.0 micrometers), Am-241 (0.02-1.0 micrometers), Sr-90 (0.01-0.5 micrometers), and P-32 (0.01-1.0 micrometers).

Suitable radioisotopes include, but are not limited to: Ni-63, C-14, Pm-147, Am-241, Sr-90, P-32, Co-60, Cs-137, H-3, Kr-85, Po-210, Pu-238, Fe-55, and combinations thereof. The radioisotope is selected based on its emission type, half-life, specific activity, and compatibility with aerosolization in the gaseous xenon environment.

Stabilization measures, such as the use of stabilizers for liquid aerosols or surface treatments for solid particles, may be employed to ensure that the aerosols remain well-dispersed and stable, preventing settling and ensuring efficient operation of the nuclear voltaic power source system.

### Wide Bandgap Semiconductor Converter

The wide bandgap semiconductor converter is positioned to intercept the scintillation photons produced by the xenon excimers. The semiconductor material is selected to have a bandgap energy appropriate for efficient absorption of the 175 nm VUV photons (photon energy approximately 7.08 eV). Suitable wide bandgap semiconductors include: diamond (bandgap approximately 5.47 eV), aluminum nitride (AlN, bandgap approximately 6.2 eV), silicon carbide (SiC, bandgap approximately 3.26 eV), gallium nitride (GaN, bandgap approximately 3.4 eV), gallium oxide (bandgap approximately 4.8-4.9 eV), boron nitride (BN, bandgap approximately 5.8 eV), and zinc oxide (ZnO, bandgap approximately 3.37 eV).

In a preferred embodiment, diamond or AlN are employed as the photovoltaic converter because their wide bandgaps more closely match the high photon energy of the xenon excimer emission, resulting in higher voltage output per absorbed photon and reduced thermalization losses.

### Electrical Contacts

Electrical contacts are provided for extracting the photogenerated charge carriers from the wide bandgap semiconductor. The contacts may include Schottky diode contacts formed from metals selected based on work function to optimize barrier height, including aluminum (work function approximately 4.28 eV), titanium (approximately 4.33 eV), gold (approximately 5.1 eV), nickel (approximately 5.15 eV), palladium (approximately 5.12 eV), and platinum (approximately 5.65 eV). Alternatively, ohmic contacts may be employed using gold, titanium, nickel, aluminum, silver, or copper, selected for their ability to form low-resistance interfaces with the semiconductor.

Specialized contacts including indium tin oxide (ITO), graphene, molybdenum (Mo), tungsten (W), and chromium (Cr) may be utilized for applications requiring transparent contacts or high-temperature environments.

### Containment Structure

The containment structure is designed as an enclosed vessel, preferably spherical, to hold the gaseous xenon and radioisotope aerosol under the specified pressure and temperature conditions. The spherical geometry maximizes the solid angle of photon capture by the wide bandgap semiconductor layer lining the interior wall. The containment structure includes radiation shielding to prevent external radiation exposure and maintains a gas-tight seal to preserve the xenon atmosphere and prevent aerosol release.

The inner surface of the containment structure may optionally include a reflective coating to redirect photons that are not initially absorbed by the semiconductor converter, increasing overall photon utilization efficiency.

What is claimed is:

1. A nuclear voltaic power source comprising:
(a) at least one radioisotope dispersed in aerosol form;
(b) a gaseous xenon scintillation medium surrounding the radioisotope aerosol, the gaseous xenon producing excimer scintillation photons upon interaction with ionizing radiation from the radioisotope;
(c) at least one wide bandgap semiconductor converter disposed to receive the excimer scintillation photons and convert them into electron-hole pairs;
(d) electrical contacts for extracting current from the wide bandgap semiconductor converter; and
(e) a containment structure enclosing the gaseous xenon and the radioisotope aerosol and providing radiation shielding.

2. The nuclear voltaic power source of claim 1, wherein the gaseous xenon is maintained at a pressure of approximately 1 to 2 atmospheres and an operating temperature from sub-zero temperatures up to approximately 60 degrees Celsius.

3. The nuclear voltaic power source of claim 1, wherein the excimer scintillation photons have a wavelength of approximately 175 nm in the vacuum ultraviolet range.

4. The nuclear voltaic power source of claim 1, wherein the wide bandgap semiconductor converter is selected from the group consisting of diamond, aluminum nitride, silicon carbide, gallium nitride, gallium oxide, boron nitride, and zinc oxide.

5. The nuclear voltaic power source of claim 1, wherein the radioisotope aerosol comprises particles having a size optimized for the selected radioisotope, the particle size being selected to maximize radiation emission into the gaseous xenon while maintaining aerosol stability.

6. The nuclear voltaic power source of claim 5, wherein the radioisotope is selected from the group consisting of Ni-63, C-14, Pm-147, Am-241, Sr-90, P-32, Co-60, Cs-137, H-3, Po-210, Pu-238, and Fe-55, and the aerosol particle diameter is in the range of approximately 0.01 to 10.0 micrometers.

7. The nuclear voltaic power source of claim 1, wherein the containment structure has a spherical geometry configured to maximize photon capture solid angle by the wide bandgap semiconductor converter.

8. The nuclear voltaic power source of claim 1, wherein the electrical contacts comprise Schottky diode contacts formed from a metal selected from the group consisting of aluminum, titanium, gold, nickel, palladium, and platinum.

9. The nuclear voltaic power source of claim 1, wherein the containment structure further comprises an internal reflective coating to redirect unabsorbed scintillation photons toward the wide bandgap semiconductor converter.

10. The nuclear voltaic power source of claim 1, wherein the wide bandgap semiconductor converter comprises diamond or aluminum nitride having a bandgap energy exceeding 5 eV for efficient conversion of 175 nm vacuum ultraviolet photons.

11. A method of generating electrical power from nuclear radiation, the method comprising:
(a) dispersing at least one radioisotope as aerosol particles within gaseous xenon maintained at a pressure of approximately 1 to 2 atmospheres;
(b) generating excimer scintillation photons by interaction of ionizing radiation from the radioisotope aerosol with the gaseous xenon;
(c) absorbing the excimer scintillation photons in a wide bandgap semiconductor converter to generate electron-hole pairs; and
(d) extracting electrical current from the wide bandgap semiconductor converter through electrical contacts.

12. The method of claim 11, wherein step (a) further comprises selecting an aerosol particle size for the radioisotope based on the radiation type and energy to maximize radiation escape from each particle into the gaseous xenon.

13. The method of claim 11, wherein step (b) produces vacuum ultraviolet photons at approximately 175 nm with a scintillation yield of approximately 46 to 53 photons per keV of deposited energy.

14. The method of claim 11, further comprising enclosing the gaseous xenon and radioisotope aerosol within a spherical containment structure having a wide bandgap semiconductor layer lining its interior surface.

15. The method of claim 11, wherein the wide bandgap semiconductor converter comprises diamond or aluminum nitride.

16. A spherical nuclear voltaic power cell comprising:
a spherical containment vessel having an interior surface;
a wide bandgap semiconductor photovoltaic layer disposed on the interior surface of the spherical containment vessel;
gaseous xenon filling the interior volume of the spherical containment vessel at a pressure of approximately 1 to 2 atmospheres;
at least one radioisotope dispersed as aerosol particles within the gaseous xenon, the radioisotope emitting ionizing radiation that interacts with the gaseous xenon to produce excimer scintillation photons;
electrical contacts disposed on the wide bandgap semiconductor photovoltaic layer for extracting photogenerated current; and
radiation shielding surrounding the spherical containment vessel.

17. The spherical nuclear voltaic power cell of claim 16, wherein the wide bandgap semiconductor photovoltaic layer comprises a material selected from the group consisting of diamond, aluminum nitride, silicon carbide, gallium nitride, gallium oxide, boron nitride, and zinc oxide.

18. The spherical nuclear voltaic power cell of claim 16, wherein the radioisotope aerosol comprises Ni-63 particles having an optimal particle radius of approximately 0.01 to 0.5 micrometers dispersed in the gaseous xenon.

19. The spherical nuclear voltaic power cell of claim 16, wherein the spherical containment vessel further comprises a VUV-reflective coating on a portion of the interior surface not covered by the wide bandgap semiconductor, configured to redirect scintillation photons toward the photovoltaic layer.

20. The spherical nuclear voltaic power cell of claim 16, further comprising a plurality of said spherical nuclear voltaic power cells connected in at least one of series and parallel to provide scalable power output.

21. A nuclear voltaic power source comprising:
a containment structure filled with gaseous xenon at a pressure of approximately 1 to 2 atmospheres;
a radioisotope aerosol uniformly dispersed within the gaseous xenon, the aerosol comprising particles having an optimized diameter selected based on the radiation type and energy of the radioisotope to maximize radiation escape from each particle into the surrounding xenon gas;
a photovoltaic converter comprising a wide bandgap semiconductor disposed to receive vacuum ultraviolet scintillation photons produced by xenon excimers formed when the ionizing radiation interacts with the xenon gas; and
electrical contacts for extracting photogenerated charge from the photovoltaic converter.

22. The nuclear voltaic power source of claim 21, wherein the optimized particle diameter for Ni-63 aerosol in xenon is approximately 0.01 to 0.5 micrometers, for C-14 aerosol is approximately 0.03 to 1.5 micrometers, for Am-241 aerosol is approximately 0.02 to 1.0 micrometers, and for Sr-90 aerosol is approximately 0.01 to 0.5 micrometers.

23. The nuclear voltaic power source of claim 21, wherein the containment structure has a spherical, cylindrical, or planar geometry.

24. The nuclear voltaic power source of claim 21, wherein the wide bandgap semiconductor is diamond having a bandgap of approximately 5.47 eV or aluminum nitride having a bandgap of approximately 6.2 eV.

25. The nuclear voltaic power source of claim 21, wherein the gaseous xenon has a scintillation yield of approximately 46 to 53 photons per keV at an emission wavelength of approximately 175 nm and a scintillation decay time of approximately 3 to 27 nanoseconds.

26. A nuclear voltaic power system comprising:
a plurality of nuclear voltaic power cells, each cell comprising a containment vessel filled with gaseous xenon at a pressure of 1 to 2 atmospheres, at least one radioisotope dispersed as aerosol particles within the gaseous xenon, a wide bandgap semiconductor converter lining at least a portion of the containment vessel interior, and electrical contacts for charge extraction; and
wherein the plurality of cells are electrically connected in at least one of a series configuration and a parallel configuration to provide a combined power output exceeding that of a single cell.

27. The nuclear voltaic power system of claim 26, wherein each containment vessel has a spherical geometry and the plurality of cells are arranged in a stacked array.

28. The nuclear voltaic power system of claim 26, wherein the radioisotope aerosol further comprises surface-treated particles or stabilizer additives to maintain uniform aerosol dispersion and prevent particle settling during operation.

29. The nuclear voltaic power system of claim 26, wherein the electrical contacts comprise at least one of: Schottky diode contacts formed from aluminum, titanium, gold, nickel, palladium, or platinum; ohmic contacts formed from gold, titanium, nickel, aluminum, silver, or copper; and specialized contacts formed from indium tin oxide, graphene, molybdenum, tungsten, or chromium.

30. The nuclear voltaic power system of claim 26, wherein the radioisotope aerosol comprises a combination of two or more different radioisotopes selected to provide complementary emission characteristics and optimized total energy output.
